(19) United States
(12) Patent Application Publication
(10) Pub. No.: US 2004/0151877 A1
(43) Pub. Date: Aug. 5, 2004

(54) Biaxially stretched white polyester films

(76) Inventors: Chang-Ho Suh, Daegu-si (KR); Ki-Bong Suh, Kyungsangbuk-do (KR); Sang-Pil Kim, Kyungsangbuk-do (KR)

Correspondence Address: ARENT FOX KINTNER PLOTKIN & KAHN, 1050 CONNECTICUT AVENUE, N.W., SUITE 400, WASHINGTON, DC, 20036, US

(21) Appl. No.: 10/354,171

(22) Filed: Jan. 30, 2003

(51) Int. Cl. B32B 1/00

(52) U.S. Cl. 428/141

(57) ABSTRACT

Disclosed is a biaxially stretched functional white polyester film, in which specific inorganic particles are added to provide different surface characteristics at the front and back surfaces thereof so that it can be used in a wide range of industrial applications such as printing, imaging, advertising and display, and a flame retardant and/or a ultraviolet stabilizer are also added to provide multi-functional properties.

### BACKGROUND OF THE INVENTION

1. Field of the Invention

The present invention relates to a biaxially stretched white polyester film. More particularly, the present invention relates to a biaxially stretched functional white polyester film, which has a white opaque appearance, and different surface characteristics at the front and back surfaces thereof so that it can be used in a wide range of industrial applications such as printing, imaging, advertising, and display, and also which has flame retardant and ultraviolet-blocking properties.

2. Background of the Related Art

Polyester, particularly polyethylene terephthalate, has excellent physical and chemical properties, and hence, is widely used for polymer-processed products. In view of the development of film applications, particle-filled polyester film are developed as substitutes for labels, cards, white boards, photo papers, imaging papers, and the like. There is widely known a method wherein a suitable amount of white inorganic particles are filled into a polymer matrix to produce a white film. Inorganic materials used for the white inorganic particles include titanium dioxide, calcium carbonate and barium sulfate. For example, GB Patent No. 1563591, GB Patent No. 1563592, and Japanese Patent Application Laid-Open No. Sho 60-30930 disclose white films in which polyester is filled with either barium sulfate or barium sulfate and polyolefin. Japanese Patent Application Laid-Open No. Sho 43-12013, Japanese Patent Application Laid-Open No. Sho 62-207337, Japanese Patent Application Laid-Open No. Sho 65-137927, and Japanese Patent Application Laid-Open No. Sho 63-161029 disclose a white polyester film containing calcium carbonate. Japanese Patent Application Laid-Open No. Sho 61-118746 discloses a white polyester film containing titanium dioxide. Japanese Patent Application Laid-Open No. Sho 62-241928 disclose a white film containing titanium dioxide and silica. Disclosed in Japanese Patent Application Laid-Open No. Sho 63-193934 is a biaxially stretched polyester film in which titanium dioxide containing zinc compounds is blended. Disclosed in Japanese Patent Application Laid-Open No. Sho 63-196632 is a biaxially stretched polyester film containing titanium dioxide, silica and an aluminum compound. Japanese Patent Application Laid-Open No. Sho 65-185532 discloses a white polyester film in which inorganic particles coated with polyolefin is blended. Japanese Patent Application Laid-Open No. Sho 66-50241 discloses a white polyester film containing calcium carbonate, barium sulfate and strontium.

However, all the white films as described above are monolayer films, which have a limitation on the improvement of functions and properties. Recently, to overcome this limitation, a laminated white film using a co-extrusion technique have been widely developed. For example, Japanese Patent Application Laid-Open No. Hei 8-252857 discloses a preparing method of a laminated white polyester film in which a polyolefin resin is added to polyester. Japanese Patent Application Laid-Open No. Hei 9-52335 discloses a co-extruded, laminated, biaxially stretched polyester film in which-a zinc compound, an aluminum compound and anatase type titanium dioxide are added. Japanese Patent Application Laid-Open No. Hei 9-85918 a laminated white polyester film, in which anatase type titanium dioxide and rutile type titanium dioxide are added. Japanese. Patent Application Laid-Open No. Hei 9-187904 discloses a laminated white polyester film, which has an intrinsic viscosity difference of 0.001 to 0.20. Japanese Patent Application Laid-Open No. Hei 11-123801 discloses a laminated white polyester film, which has a transmission density of 0.2 or more, a hue b value of less than 2, and a 60-degree gloss of 60% or more. Japanese Patent Application Laid-Open No. Hei 11-157038 discloses a laminated white polyester film, which contains titanium oxide particles, barium sulfate particles and a fluorescent whitening agent. Japanese Patent Application Laid-Open No. Hei 11-170462 discloses a laminated white polyester film, which contains titanium oxide particles, barium sulfate particles and a fluorescent whitening agent, and has an apparent density of 0.5 to 1.3 g/cm³. Japanese Patent Application Laid-Open No. Hei 11-254622 discloses a laminated white polyester film, which contains anatase type titanium dioxide and a white pigment having a zinc atom concentration of up to 50 ppm. U.S. Pat. No. 6143408 discloses a laminated white polyester film, which has a transmission density of 0.2 or more and a hue b value of less than 2, and contains a primer layer. U.S. Pat. No. 2001-0036542 discloses a laminated white film, which consists of an outer layer free of voids and an inner layer containing a void-forming agent.

Meanwhile, gloss, which is one of principal physical properties of a biaxially stretched polyester film, is optically determined in evaluating appearance of the film surface, and depends on the ability to reflect straight light. The gloss is sensed by the human eye and thus subjective. Accordingly, the difference between visually observed properties needs to be defined as an objective value by instrumental analysis. Namely, the ratio of the intensity of reflected light to the intensity of incident light can be measured as a certain angle. More specifically, it is determined as a function of the reflective index of a surface, the angle of incident light and the surface roughness. If a reflection surface is flat, the intensity of reflected light can be predicted from a Fresnel equation at a given angle of incident light. For example, when the reflective index is constant, an increase in the incident angle shows an increase in the ratio of the intensity of reflected light to the intensity of incident light. Generally, in gloss measurement, the gloss value of a flat plate having a known reflective index is compared to the gloss value of a material to be measured. Accordingly, the gloss is expressed as the ratio between the intensity of reflected light of the material to be measured and that of the standard plate. In the film, a gloss difference between a stretching direction and a direction perpendicular to the stretching direction occurs due to a difference in the stretching mechanism. This gloss difference reduces as the added amount of particles increases. It is assumed that, since the particles added in a large amount controls the degree of stretching, a difference in reflective index may be reduced. Also, when the added amount of particles is large, the gloss depends more on a quenching effect caused by particles and voids within a matrix than on a quenching effect caused by the surface roughness, whereby the gloss difference caused by a difference in surface roughness is offset that much. With respect to the change in gloss according to thickness of a film when particle contents are same, as the thickness is increased, the gloss tends to somewhat decrease since the light scattering ability of particles in a polymer matrix is increased.

The present invention is to provide a highly functional white film, which can be used in applications including printing, imaging, advertising and display. In such graphic applications, surface properties of the white film are of importance. In other words, the preference and quality of products significantly vary depending on the color and gloss, etc. of the surface. The gloss of the products varies depending on physical properties of a film, or the surface design of a substrate, and the surface properties are accomplished by artificially controlling the surface roughness of the substrate. The gloss of the substrate has an effect on a subsequent process such as printing, and also on the quality of the products. An object of the present invention is to provide a multi-functional and high-functional white film, which can be henceforth used in various applications such as electrical and electronic materials.

Furthermore, thermoplastic resins, including polyester, are widely used, but they have poor thermal resistances. The resins are thermally decomposed by the application of heat, and at the same time, emits toxic gas. Thus, there is required an effort to prevent and inhibit these problems. Besides, if a film that is usually used in daily life is rendered flame retardant and fireproof, it is believed to be particularly beneficial. Furthermore, the thermoplastic resins, including polyester, have a disadvantage that they are unstable against ultraviolet rays because of their structure, though they are widely used. Ultraviolet rays have a high wavelength of 200 to 400 nm, and hence, have a direct effect on the decomposition of a polymer material by contact with the polymer material. In order to minimize the decomposition of the polymer material caused by ultraviolet rays, a light stabilizer is generally added to the polymer material. The light stabilizer usually used includes compounds having an aromatic structure which inhibits the photodecomposition of the polymer material caused by ultraviolet rays. More specifically, a major cause for aging of plastics or film products used outdoors is the ultraviolet rays in sunlight. The energy of ultraviolet rays having the wavelength range of 200 to 400 nm breaks chemical bonds of a polymer to produce free radicals, which induce chain breakage and cross-linking, etc., thereby causing de-coloration, cracks on the surface of products, the deterioration of mechanical properties, etc. Such deteriorations in the properties of the polymer material can be inhibited by adding an ultraviolet stabilizer to a polymer-processed product or a polymer film. Thus, the ultraviolet stabilizer means a compound for preventing or inhibiting the physical and chemical processes of the deterioration of physical properties caused by light. The reaction of the physical property deterioration caused by ultraviolet rays is the reaction occurring in the presence of oxygen in air, and substantially means the oxidation reaction, which is initiated and accelerated by ultraviolet rays. The action of the ultraviolet stabilizer includes a method using ultraviolet absorption, a method of preventing the internal decomposition by blocking ultraviolet rays, and a method using the absorption of reactive radicals. Generally, a suitable combination of an antioxidant and an ultraviolet stabilizer is most ideal. The stabilization mechanism of the ultraviolet stabilizer is divided into the following two methods. In a first method, ultraviolet energy is blocked or selectively absorbed so that it is emitted in other energy forms harmless to a polymer material, or a chromophore of an activated polymer material is suppressed to retard the initiation of photodecomposition reaction. This method includes a light blocker, an ultraviolet absorber, and a quencher. In a second method, it is reacted with free radicals or hydroperoxides upon photodecomposition to stop the production of free radicals and decompose peroxides, thereby retarding the photodecomposition reaction. This method includes a radical scavenger, a peroxide decomposing agent, and a hindered amine stabilizer. In the fundamental mechanism of the ultraviolet absorption, an ultraviolet wavelength harmful to a resin is absorbed to emit in heat or other stable forms. For high ultraviolet absorption force, a compound having a very stable molecular structure is required. This is because the compound can be reacted by itself at high energy level when the absorbed light energy is emitted in the other forms.

### SUMMARY OF THE INVENTION

An object of the present invention is to provide a multi-functional and high-functional white film, which can be used in various applications such as electrical and electronic materials.

To achieve the above object, in one embodiment, the present invention provides a laminated white polyester film having a three-layered structure (A/B/C) comprising: (A) a photic layer having a 60 degree gloss of 100% or more, (B) a layer containing 5 to 30% by weight of inorganic particles and up to 0.5% by weight of a fluorescent whitening agent, and (C) an aphotic layer having a 60 degree gloss of 50% or less.

In another embodiment, the present invention provides a laminated white polyester film having a three-layered structure (A/B/C) comprising: (A) a photic layer having a 60 degree gloss of 100% or more, (B) a layer containing 5 to 30% by weight of inorganic particles and up to 0.5% by weight of a fluorescent whitening agent, and (C) an aphotic layer having a 60 degree gloss of 50% or less, in which at least one layer contains 0.01 to 5% by weight of a flame retardant.

In another embodiment, the present invention provides a laminated white polyester film having a three-layered structure (A/B/C) comprising: (A) a photic layer having a 60 degree gloss of 100% or more; (B) a layer containing 5 to 30% by weight of inorganic particles and up to 0.5% by weight of a fluorescent whitening agent, and (C) an aphotic layer having a 60 degree gloss of 50% or less, in which at least one layer contains 0.01 to 5% by weight of an ultraviolet stabilizer.

In another embodiment, the present invention provides a laminated white polyester film having a three-layered structure (A/B/C) comprising: (A) a photic layer having a 60 degree gloss of 100% or more, (B) a layer containing 5 to 30% by weight of inorganic particles and up to 0.5% by weight of a fluorescent whitening agent, and (C) an aphotic layer having a 60 degree gloss of 50% or less, in which at least one layer contains a flame retardant and an ultraviolet stabilizer in an amount of 0.01 to 5% by weight, respectively.

### BRIEF DESCRIPTION OF THE DRAWINGS

The above and other objects, features and advantages of the present invention will be apparent from the following detailed description of the preferred embodiments of the invention in conjunction with the accompanying drawing, in which:

FIG. 1 is a cross-section view showing an embodiment of the laminated white film according to the present invention.

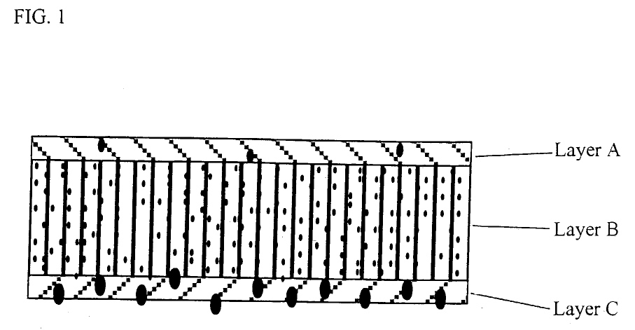

### DETAILED DESCRIPTION OF THE PREFERRED EMBODIMENT

Now, the present invention is described in detail.

The flame retardant used in the practice of the present invention includes additive-type or reactive-type flame retardants, such as alumina trihydrate-, halogen-, phosphorus-, and halogenated phosphorus-based flame retardants. The ultraviolet stabilizer used in the practice of the present invention includes benzophenone-, benzotriazole-, resorcinol monobenzoate-, salicylate-, hydroxy benzoate-, and formamidine-based ultraviolet absorbers, hindered amine-based ultraviolet stabilizers, and imino ester-based ultraviolet stabilizers.

The production of the laminated white polyester film can be carried out using a co-extrusion technique based on a technique for the production of a mono-layered white polyester film. The technique for the production of the white film requires an advanced process technique in addition to a technique for the production of a general polyester film. In particular, since a wide polyester production line is generalized nowadays, process technology development must be first achieved in order to produce a white polyester film filled with large amounts of inorganic particles. Since titanium dioxide filled in the polyester film at large amounts cause a reduction in the intrinsic viscosity of a polyester matrix, the intrinsic viscosity of the polyester matrix must be maintained at a suitable level. If the viscosity is too high, breakage will occur with high possibility upon film production. Since the inorganic particles contained at large amounts acts as a nucleating agent of a polymer melt during a casting process, a crystallization controlling technique is required. Furthermore, since these particles cause the restriction of matrix stretchability, a stretching mechanism different from the conventional polyester film is required. The average particle size of titanium dioxide used in the present invention is 0.05 to 5 μm, and preferably 0.1 to 0.5 μm. If the particle size is less than 0.05 μm, the dispersibility of particles in a film will be reduced due to particle cohesion. If the particle size is more than 5 μm, the interaction force between particle and particle and between particle and matrix is weak, so that bubbles are significantly produced during a stretching process, thereby making the process unstable. Meanwhile, titanium dioxide is filled in the matrix at the amount of 5 to 30% by weight, and preferably 10 to 20% by weight. If the filling amount of the titanium dioxide is less than 5% by weight, whiteness will be low and coverage will not reach a suitable value. If the filling amount is more than 30% by weight, flow characteristics of the polymer will be changed (e.g., a reduction in the swelling phenomenon of a melt, and an increase in the sagging phenomenon of a melt), and stretchability is reduced, thereby making a film producing process difficult. Moreover, the fluorescent whitening agent used in the present invention includes bisbenzoxazoles, and preferably 2,2′-(1,2-ethenediyldi-4,1-phenylene)bisbenzoxazoles. The fluorescent whitening agent is added at the amount of 0.005 to 0.5% by weight, and preferably 0.05 to 0.2% by weight. If the adding amount of the fluorescent whitening agent is less than 0.005% by weight, a whitening effect will be insufficient, and if the adding amount is more than 0.5% by weight, whiteness will be reduced due to excessive reflectivity.

In order to adjust surface characteristics of the film, in the present invention, the surface roughness of the film is inputted using a co-extrusion technique and an inorganic particle design technique to obtain the desired gloss. The three-layered substrate described in the present invention, each layer of which consists of a material having a flow characteristic different from materials used in other layers is designed so as to solve problems such as extrusion instability by flow mechanisms of the respective materials. The silicon dioxide particles used in the present invention have an average particle size of 1 to 10 μm, preferably 2 to 5 μm. The added amount of the particles are 0.1 to 5% by weight, preferably 0.5 to 1% by weight. If the average particle size is less than 1 μm while the added amount is greater than the upper limit of the foregoing range, or if the added amount is less than 0.1% by weight while the average particle size exceeds the upper limit of the foregoing range, it is impossible to satisfactory quenching effect and print quality. In other hand, addition of particles of a relatively large size (exceeding 10 μm) in a large amount (exceeding 5% by weight) may cause deterioration in film formability.

Meanwhile, the flame retardant used for ignition delay in the present invention includes additive flame retardants such as alumina trihydrates, halogen-containing compounds, phosphorus- based compounds, halogenated phosphorus compounds or reactive flame retardants. For the flame retardants of alumina trihydrates, it is necessary to add in a large amount so as to sufficiently inhibit inflammability. The flame retardants of alumina trihydrates are cheap and do not induce incomplete combustion. Therefore, they do not significantly increase but reduce smoke or toxic gas. It is well-known that halogen containing compounds are effective in rendering a compound flame retardant and I>Br>Cl>F are more effective in this order. Thus, iodine-containing compounds are most effective in ignition delay. However, they are very expensive and fall short of thermal stability for application in resins. Therefore, bromine- and chlorine-containing compounds are usually used. Examples of the additive flame retardants include chlorinated paraffin, chlorinated cycloaliphatics, brominated aromatics, brominated aromatic polymers, etc. and examples of the reactive flame retardants include chlorendic acid, chlorendic anhydride, tetrabromobisphenol, tetrabromophthalic anhydride, etc. The phosphorus-based flame retardants include phosphoric acid, phosphates, etc. and specific examples thereof include ammonium phosphates, ammonium phosphate polymers, alkyl phosphates, alkyl phosphonates, triaryl phosphates, halogenated alkyl phosphonates, halogenated alkyl phosphates, phosphonium salts, phosphagen, etc. Other flame retardants which can be used in the present invention to inhibit inflammability of the particles-filled film.

The ultraviolet absorbers most commonly used in the art include hydroxy benzophenones and hydroxyphenyl benzotriazoles. The benzophenone ultraviolet absorbers are excellent in compatibility to resins and thus, have been widely used. However, they are inferior to the benzotriazole ultraviolet absorbers in ultraviolet absorption at a wavelength of 340 nm or more. The benzotriazole ultraviolet absorbers show absorption over a wider range of wavelengths and are usually used in colorless products and quality products. In addition, examples of the flame retardants useful in the present invention include resorcinol monobenzoates, salicylates, hydroxy benzoates, formamidines, etc. According to the present invention, the capture of free radicals is performed to capture free radicals which are mediators of oxidation rather than to eliminate energy source, as described above. The methods for rendering a resin to be stable to ultraviolet rays by capturing free radicals have been developed lately. It is probable that these methods did not begin to be studied before phenone antioxidants which inhibit activity of free radicals have no effect in ultraviolet oxidation. Representative examples of the ultraviolet stabilizers by capture of free radicals include hindered amines (HALS). The HALS is readily oxidized and converted into a nixtroxyl radical, which react with a polymer radical to produce a hydroxylamine ether. The HALS is excellent in surface protection effect. Also, it can be applied to a product with a thin section and thus, there is an increased demand along with development of special grades. Further, cyclic imino esters having an aromatic nucleus, two carbon atoms of which forms a part of the imino ester ring, as disclosed in U.S. Pat. No. 4,446,262 can be used as a ultraviolet stabilizer. The imino ester ultraviolet stabilizer has been reported to have excellent stability to heat and oxidation.

For measurement of the characteristic property according to the present invention, the 60-degree gloss is determined according to ASTM method D523, the haze is determined according to ASTM method D1003, and the flame retardant is expressed by a L01 value, which is a minimum concentration % (v/v) of oxygen needed for flame ignition. If the L01 value is high, the inflammability is low. The L01 value is determined using a specimen of 14 cm×6 cm×50 μm in flammability unit. The total flow rate was adjusted to be 18 l/min by controlling flow rates of oxygen and nitrogen and the oxygen/nitrogen rate is varied. The initial oxygen level was set to 25%. The upper part of the specimen was ignited using a butane burner. When the specimen did not burn well, the oxygen level was increased. On the other hand, when the specimen catches fire, the oxygen level was reduced. The ultraviolet stability of the film was determined by measuring transmissions over the wavelength range of 310 to 380 nm using a ultraviolet spectrometer and calculating an average ultraviolet rejection rate according to the following equation:

Average ultraviolet rejection rate (%)=100−{(T1+T2)×0.36+(T3+T4)×0.14}

in which, T1 is a maximum transmission over the wavelength range of 310 to 380 nm, T2 is a minimum transmission over the wavelength range of 310 to 380 nm, T3 is a transmission at a wavelength of 360 nm, and T4 is a transmission at a wavelength of 380 nm.

### EXAMPLE 1

A film was prepared using five polyethylene terephthalate-based materials, as follows: PM1, polyethylene terephthalate free of particles having an intrinsic viscosity of 0.65 dl/g; PM2, polyethylene terephthalate containing 50% by weight of titanium dioxide having an average particle size of 0.3 μm and 0.15% by weight of a fluorescent whitening agent; PM3, polyethylene terephthalate containing 5% by weight of silicon dioxide having an average particle size of 4 μm; PM4, polyethylene terephthalate containing 5% by weight of silicon dioxide having an average particle size of 2 μm; and PM5, polyethylene terephthalate containing 0.7% by weight of a phosphorous-based flame retardant.

Three compositions were prepared by compounding the ingredients of PM1, PM2, PM3, PM4 and PM5 according to the ratio (% by weight) listed in Table 1, laminated in a feed block as a three-layer construction, extruded through a co-extrusion die and cooled in a casting drum to produce a sheet. The sheet was stretched longitudinally 3 times at a temperature of 75 to 130° C. and then laterally 3.3 times at 90 to 145° C., followed by a heat treatment at a temperature in the range of 215 to 235° C. to give a film having an average thickness of 50 μm. Thicknesses of respective layers of the prepared film were 3 μm/44 μm/3 μm.

TABLE 1

| | | Layer | | | | | | | |
|---|---|---|---|---|---|---|---|---|---|
| | | thickness | Content (% by weight) | | | | | | |
| | Layer | (μm) | PM1 | PM2 | PM3 | PM4 | PM5 | PM6 | |
| Example 1 | A | 3 | 65 | 0 | 0 | 10 | 25 | 0 | Laminate |
| | B | 44 | 45 | 30 | 0 | 0 | 25 | 0 | |
| | C | 3 | 30 | 0 | 45 | 0 | 25 | 0 | |
| Example 2 | A | 5 | 65 | 0 | 0 | 10 | 25 | 0 | Laminate |
| | B | 40 | 45 | 30 | 0 | 0 | 25 | 0 | |
| | C | 5 | 30 | 0 | 45 | 0 | 25 | 0 | |
| Example 3 | A | 3 | 75 | 0 | 0 | 10 | 15 | 0 | Laminate |
| | B | 44 | 55 | 30 | 0 | 0 | 15 | 0 | |
| | C | 3 | 20 | 0 | 65 | 0 | 15 | 0 | |
| Example 4 | A | 5 | 75 | 0 | 0 | 10 | 15 | 0 | Laminate |
| | B | 40 | 55 | 30 | 0 | 0 | 15 | 0 | |
| | C | 5 | 20 | 0 | 65 | 0 | 15 | 0 | |
| Example 5 | A | 3 | 80 | 0 | 0 | 10 | 0 | 10 | Laminate |
| | B | 44 | 60 | 30 | 0 | 0 | 0 | 10 | |
| | C | 3 | 45 | 0 | 45 | 0 | 0 | 10 | |
| Example 6 | A | 5 | 80 | 0 | 0 | 10 | 0 | 10 | Laminate |
| | B | 40 | 60 | 30 | 0 | 0 | 0 | 10 | |
| | C | 5 | 45 | 0 | 45 | 0 | 0 | 10 | |
| Example 7 | A | 3 | 80 | 0 | 0 | 10 | 0 | 10 | Laminate |
| | B | 44 | 60 | 30 | 0 | 0 | 0 | 10 | |
| | C | 3 | 25 | 0 | 65 | 0 | 0 | 10 | |
| Example 8 | A | 5 | 80 | 0 | 0 | 10 | 0 | 10 | Laminate |
| | B | 40 | 60 | 30 | 0 | 0 | 0 | 10 | |
| | C | 5 | 25 | 0 | 65 | 0 | 0 | 10 | |
| Example 9 | A | 3 | 55 | 0 | 0 | 10 | 25 | 10 | Laminate |
| | B | 44 | 35 | 30 | 0 | 0 | 25 | 10 | |
| | C | 3 | 20 | 0 | 45 | 0 | 25 | 10 | |
| Example 10 | A | 5 | 55 | 0 | 0 | 10 | 25 | 10 | Laminate |
| | B | 40 | 35 | 30 | 0 | 0 | 25 | 10 | |
| | C | 5 | 20 | 0 | 45 | 0 | 25 | 10 | |
| Com. | — | 50 | 70 | 30 | 0 | 0 | 0 | 0 | Single layer |
| Example 1 | | | | | | | | | |
| Com. | — | 50 | 60 | 30 | 10 | 0 | 0 | 0 | Single layer |
| Example 2 | | | | | | | | | |

### EXAMPLE 2

A three-layered film with an average thickness of 50 μm was prepared by following the process of Example 1 and using the ingredients of PM1, PM2, PM3, PM4 and PM5, as defined in Example 1, in the ratio (% by weight) listed in Table 1. Thicknesses of respective layers of the prepared film were 5 μm/40 μm/5 μm.

### EXAMPLE 3

A three-layered film with an average thickness of 50 μm was prepared by following the process of Example 1 and using the ingredients of PM1, PM2, PM3, PM4 and PM5, as defined in Example 1, in the ratio (% by weight) listed in Table 1. Thicknesses of respective layers of the prepared film were 3 μm/44 μm/3 μm.

### EXAMPLE 4

A three-layered film with an average thickness of 50 μm was prepared by following the process of Example 1 and using the ingredients of PM1, PM2, PM3, PM4 and PM5, as defined in Example 1, in the ratio (% by weight) listed in Table 1. Thicknesses of respective layers of the prepared film were 5 μm/40 μm/5 μm.

### EXAMPLE 5

A film was prepared using five polyethylene terephthalate-based materials, as follows: PM1, polyethylene terephthalate free of particles having an intrinsic viscosity of 0.65 dl/g; PM2, polyethylene terephthalate containing 50% by weight of titanium dioxide having an average particle size of 0.3 μm and 0.15% by weight of a fluorescent whitening agent (OB-1); PM3, polyethylene terephthalate containing 5% by weight of silicon dioxide having an average particle size of 4 μm; PM4, polyethylene terephthalate containing 5% by weight of silicon dioxide having an average particle size of 2 μm; and PM6, polyethylene terephthalate containing 7% by weight of a phosphorous-based ultraviolet stabilizer.

Three compositions were prepared by compounding the ingredients of PM1, PM2, PM3, PM4 and PM6 according to the ratio (% by weight) listed in Table 1, laminated in a feed block as a three-layer construction, extruded through a co-extrusion die and cooled in a casting drum to produce a sheet. The sheet was stretched longitudinally 3 times at a temperature of 75 to 130° C. and then laterally 3.3 times at 90 to 145° C., followed by a heat treatment at a temperature in the range of 215 to 235° C. to give a film having an average thickness of 50 μm. Thicknesses of respective layers of the prepared film were 3 μm/44 μm/3 μm.

### EXAMPLE 6

A three-layered film with an average thickness of 50 μm was prepared by following the process of Example 5 and using the ingredients of PM1, PM2, PM3, PM4 and PM6, as defined in Example 5, in the ratio (% by weight) listed in Table 1. Thicknesses of respective layers of the prepared film were 5 μm/40 μm/5 μm.

### EXAMPLE 7

A three-layered film with an average thickness of 50 μm was prepared by following the process of Example 5 and using the ingredients of PM1, PM2, PM3, PM4 and PM6, as defined in Example 5, in the ratio (% by weight) listed in Table 1. Thicknesses of respective layers of the prepared film were 3 μm/44 μm/3 μm.

### EXAMPLE 8

A three-layered film with an average thickness of 50 μm was prepared by following the process of Example 5 and using the ingredients of PM1, PM2, PM3, PM4 and PM6, as defined in Example 5, in the ratio (% by weight) listed in Table 1. Thicknesses of respective layers of the prepared film were 5 μm/40 μm/5 μm.

### EXAMPLE 9

A film was prepared using six polyethylene terephthalate-based materials, as follows: PM1, polyethylene terephthalate free of particles having an intrinsic viscosity of 0.65 dl/g; PM2, polyethylene terephthalate containing 50% by weight of titanium dioxide having an average particle size of 0.3 μm and 0.15% by weight of a fluorescent whitening agent (OB-1); PM3, polyethylene terephthalate containing 5% by weight of silicon dioxide having an average particle size of 4 μm; PM4, polyethylene terephthalate containing 5% by weight of silicon dioxide having an average particle size of 2 μm; PM5, polyethylene terephthalate containing 0.7% by weight of a phosphorous-based flame retardant; and PM6, polyethylene terephthalate containing 7% by weight of a phosphorous-based ultraviolet stabilizer.

Three compositions were prepared by compounding the ingredients of PM1, PM2, PM3, PM4, PM5 and PM6 according to the ratio (% by weight) listed in Table 1, laminated in a feed block as a three-layer construction, extruded through a co-extrusion die and cooled in a casting drum to produce a sheet. The sheet was stretched longitudinally 3 times at a temperature of 75 to 130° C. and then laterally 3.3 times at 90 to 145° C., followed by a heat treatment at a temperature in the range of 215 to 235° C. to give a film having an average thickness of 50 μm. Thicknesses of respective layers of the prepared film were 3 μm/44 μm/3 μm.

### EXAMPLE 10

A three-layered film with an average thickness of 50 μm was prepared by following the process of Example 9 and using the ingredients of PM1, PM2, PM3, PM4, PM5 and PM6, as defined in Example 9, in the ratio (% by weight) listed in Table 1. Thicknesses of respective layers of the prepared film were 5 μm/40 μm/5 μm.

### Comparative Example 1

A film was prepared using two polyethylene terephthalate-based materials, as follows: PM1, polyethylene terephthalate free of particles having an intrinsic viscosity of 0.65 dl/g; and PM2, polyethylene terephthalate containing 50% by weight of titanium dioxide having an average particle size of 0.3 μm and 0.15% by weight of a fluorescent whitening agent (OB-1).

A sheet was prepared by constructing a single layer comprising the ingredients of PM1 and PM2 according to the ratio (% by weight) listed in Table 1, extruding the single layer through a co-extrusion die, followed by cooling in a casting drum to produce a sheet. The sheet was stretched longitudinally 3 times at a temperature of 75 to 130° C. and then laterally 3.3 times at 90 to 145° C., followed by a heat treatment at a temperature in the range of 215 to 235° C. to give a film having an average thickness of 50 μm. The resulting film was a single-layered film.

### Comparative Example 2

A film was prepared using three polyethylene terephthalate-based materials, as follows: PM1, polyethylene terephthalate free of particles having an intrinsic viscosity of 0.65 dl/g; PM2, polyethylene terephthalate containing 50% by weight of titanium dioxide having an average particle size of 0.3 μm and 0.15% by weight of a fluorescent whitening agent (OB-1); and PM3, polyethylene terephthalate containing 5% by weight of silicon dioxide having an average particle size of 4 μm.

A sheet was prepared by constructing a single layer comprising the ingredients of PM1, PM2 and PM3 according to the ratio (% by weight) listed in Table 1, extruding the single layer through a co-extrusion die, followed by cooling in a casting drum to produce a sheet. The sheet was stretched longitudinally 3 times at a temperature of 75 to 130° C. and then laterally 3.3 times at 90 to 145° C., followed by a heat treatment at a temperature in the range of 215 to 235° C. to give a film having an average thickness of 50 μm. The resulting film was a single-layered film.

Particle types, and contents of particles, flame retardants and ultraviolet stabilizers used in Examples and Comparative examples are shown in Table 2 below. Glosses, L01 values and ultraviolet rejection rates are shown in Table 3 below.

TABLE 2

| | | Layer | Content (% by weight) | | | | |
|---|---|---|---|---|---|---|---|
| | | thickness | titanium | | | ultraviolet | ultraviolet |
| | Layer | (μm) | dioxde | 4 μm silica | 2 μm silica | stabilizer | stabilizer |
| Example 1 | A | 3 | 0 | 0 | 0.1 | 0.175 | 0 |
| | B | 44 | 15 | 0 | 0 | | |
| | C | 3 | 0 | 2.25 | 0 | | |
| Example 2 | A | 5 | 0 | 0 | 0.1 | 0.175 | 0 |
| | B | 40 | 15 | 0 | 0 | | |
| | C | 5 | 0 | 2.25 | 0 | | |
| Example 3 | A | 3 | 0 | 0 | 0.1 | 0.105 | 0 |
| | B | 44 | 15 | 0 | 0 | | |
| | C | 3 | 0 | 3.25 | 0 | | |
| Example 4 | A | 5 | 0 | 0 | 0.1 | 0.105 | 0 |
| | B | 40 | 15 | 0 | 0 | | |
| | C | 5 | 0 | 3.25 | 0 | | |
| Example 5 | A | 3 | 0 | 0 | 0.1 | 0 | 0.7 |
| | B | 44 | 15 | 0 | 0 | | |
| | C | 3 | 0 | 2.25 | 0 | | |
| Example 6 | A | 5 | 0 | 0 | 0.1 | 0 | 0.7 |
| | B | 40 | 15 | 0 | 0 | | |
| | C | 5 | 0 | 2.25 | 0 | | |
| Example 7 | A | 3 | 0 | 0 | 0.1 | 0 | 0.7 |
| | B | 44 | 15 | 0 | 0 | | |
| | C | 3 | 0 | 3.25 | 0 | | |
| Example 8 | A | 5 | 0 | 0 | 0.1 | 0 | 0.7 |
| | B | 40 | 15 | 0 | 0 | | |
| | C | 5 | 0 | 3.25 | 0 | | |
| Example 9 | A | 3 | 0 | 0 | 0.1 | 0.175 | 0.7 |
| | B | 44 | 15 | 0 | 0 | | |
| | C | 3 | 0 | 2.25 | 0 | | |
| Example 10 | A | 5 | 0 | 0 | 0.1 | 0.175 | 0.7 |
| | B | 40 | 15 | 0 | 0 | | |
| | C | 5 | 0 | 2.25 | 0 | | |
| Com. | — | — | 15 | 0 | 0 | 0 | 0 |
| Example 1 | | | | | | | |
| Com. | — | — | 15 | 0.5 | 0 | 0 | 0 |
| Example 2 | | | | | | | |

TABLE 3

| | | Layer | | | Ultraviolet rejection |
|---|---|---|---|---|---|
| | | thickness | | LOI | rate |
| | Layer | (μm) | Gloss (%) | (% by volume) | (% by volume) |
| Example 1 | A | 3 | 142 | 29 | 39 |
| | B | 44 | — | | |
| | C | 3 | 40 | | |
| Example 2 | A | 5 | 139 | 28 | 39 |
| | B | 40 | — | | |
| | C | 5 | 29 | | |
| Example 3 | A | 3 | 144 | 24 | 40 |
| | B | 44 | — | | |
| | C | 3 | 25 | | |
| Example 4 | A | 5 | 136 | 25 | 38 |
| | B | 40 | — | | |
| | C | 5 | 19 | | |
| Example 5 | A | 3 | 141 | 21 | 99 |
| | B | 44 | — | | |
| | C | 3 | 39 | | |
| Example 6 | A | 5 | 138 | 20 | 99 |
| | B | 40 | — | | |
| | C | 5 | 28 | | |
| Example 7 | A | 3 | 143 | 20 | 99 |
| | B | 44 | — | | |
| | C | 3 | 24 | | |
| Example 8 | A | 5 | 135 | 21 | 99 |
| | B | 40 | — | | |
| | C | 5 | 18 | | |
| Example 9 | A | 3 | 139 | 30 | 99 |
| | B | 44 | — | | |
| | C | 3 | 38 | | |
| Example 10 | A | 5 | 136 | 29 | 99 |
| | B | 40 | — | | |
| | C | 5 | 27 | | |
| Com. Example 1 | — | — | 75 | 20 | 38 |
| Com. Example 2 | — | — | 45 | 21 | 38 |

The forgoing embodiments are merely exemplary and are not to be construed as limiting the present invention. The present teachings can be readily applied to other types of apparatuses. The description of the present invention is intended to be illustrative, and not to limit the scope of the claims. Many alternatives, modifications, and variations will be apparent to those skilled in the art.

What is claimed is:

1. A biaxially stretched white polyester film having a three-layered structure (A/B/C) comprising:
(A) A glossy layer having a 60 degree gloss of 100% or more,
(B) a layer containing 5 to 30% by weight of inorganic particles and up to 0.5% by weight of a fluorescent whitening agent, and
(C) a matte layer having a 60 degree gloss of 50% or less.

2. A biaxially stretched white polyester film having a three-layered structure (A/H/C) comprising:
(A) A glossy layer having a 60 degree gloss of 100% or more,
(B) a layer containing 5 to 30% by weight of inorganic particles and up to 0.5% by weight of a fluorescent whitening agent, and
(C) a matte layer having a 60 degree gloss of 50% or less,
in which at least one layer contains 0.01 to 5% by weight of a flame retardant.

3. A biaxially stretched white polyester film having a three-layered structure (A/B/C) comprising:
(A) a glossy layer having a 60 degree gloss of 100% or more,
(B) a layer containing 5 to 30% by weight of inorganic particles and up to 0.5% by weight of a fluorescent whitening agent, and
(C) A matte layer having a 60 degree gloss of 50% or less,
in which at least one layer contains 0.01 to 5% by weight of an ultraviolet stabilizer.

4. A biaxially stretched white polyester film having a three-layered structure (A/B/C) comprising:
(A) a glossy layer having a 60 degree gloss of 100% or more,
(B) a layer containing 5 to 30% by weight of inorganic particles and up to 0.5% by weight of a fluorescent whitening agent, and
(C) a matte layer having a 60 degree gloss of 50% or less,
in which at least one layer contains a flame retardant and an ultraviolet stabilizer in an amount of 0.01 to 5% by weight, respectively.

5. The biaxially stretched white polyester film according to any one of claims 1 to 4, wherein the inorganic particles have an average particle size of 0.1 to 10 μm.

6. The biaxially stretched white polyester film according to any one of claims 1 to 4, wherein the inorganic particles comprise at least one of titanium dioxide and barium sulfate.

7. The biaxially stretched white polyester film according to any one of claims 1 to 4, wherein the layer of (A) contains up to 0.5% by weight of silica particles having an average particle size of 0.05 to 5 μm.

8. The biaxially stretched white polyester film according to any one of claims 1 to 4, wherein the layer of (C) contains 0.5 to 10% by weight of silica particles having an average particle size of 0.5 to 20 μm.

9. The biaxially stretched white polyester film according to any one of claims 1 to 4, wherein the fluorescent whitening agent comprises bisbenzoxazoles.

10. The biaxially stretched white polyester film according to claim 2 to 4, wherein the flame retardant comprise additive-type or reactive-type flame retardants, such as alumina trihydrate-, halogen-, phosphorus-, and halogenated phosphorus-based flame retardants.

11. The biaxially stretched white polyester film according to claim 3 or 4, wherein the ultraviolet stabilizer comprises benzophenone-, benzotriazole-, resorcinol monobenzoate-, salicylate-, hydroxy benzoate-, and formamidine-based ultraviolet absorbers, hindered amine-based ultraviolet stabilizers, and imino ester-based ultraviolet stabilizers.
